(19) United States
(12) Patent Application Publication
(10) Pub. No.: US 2007/0243403 A1
(43) Pub. Date: Oct. 18, 2007

(54) Recording paper

(75) Inventors: Tsukasa Matsuda, Kanagawa (JP); Eizo Kurihara, Kanagawa (JP); Shoji Yamaguchi, Kanagawa (JP); Kunihiro Takahashi, Kanagawa (JP); Mario Fuse, Kanagawa (JP); Tomofumi Tokiyoshi, Tokyo (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/641,787

(22) Filed: Dec. 20, 2006

(30) Foreign Application Priority Data
Apr. 14, 2006 (JP) 2006-112136

(51) Int. Cl. H01F 1/00

(52) U.S. Cl. 428/611

(57) ABSTRACT

Disclosed is a recording paper containing pulp fibers and magnetic fibers, in which the fiber orientation ratio is within a range selected from the range from 1.8 to 3.0 and the range from 1.0 to 1.3 as measured by an ultrasonic wave velocity method.

### BACKGROUND

1. Technical Field

The present invention relates to recording paper containing magnetic fibers on which printing with an ordinary recording material such as toner or ink is possible and in which recording and reproduction of information is possible by magnetic methods.

2. Related Art

For special documents such as paper money and securities, it is extremely important to prevent them from being forged.

On the other hand, with the recent distribution of computers, multifunctional machines, and network, it has become possible to readily obtain the desired information from enormous volume of information and to print and copy the obtained information. Accordingly, a problem is being highlighted in that printed matter on which highly secret information was illegally copied or printed is taken out and the confidential information is thereby leaked out. Therefore, in order to prevent leaking of confidential information through taking out of such printed matter on which the confidential information was illegally copied or printed, various devices and methods have been proposed with reinforced function of ensuring information security.

### SUMMARY

According to an aspect of the invention, there is provided a recording paper that contains pulp fibers and magnetic fibers and has a fiber orientation ratio within the range from 1.8 to 3.0 or the range from 1.0 to 1.3 as measured by an ultrasonic wave traveling velocity method.

### BRIEF DESCRIPTION OF THE DRAWINGS

Embodiments of the present invention will be described in detail based on the following figures, wherein:

FIG. 1A to FIG. 1C are schematic diagrams showing examples of the orientation condition of pulp fibers and magnetic fibers in relation to the fiber orientation ratio thereof; and

FIG. 2A to FIG. 2C are graphs for explaining a large Barkhausen effect.

### DETAILED DESCRIPTION

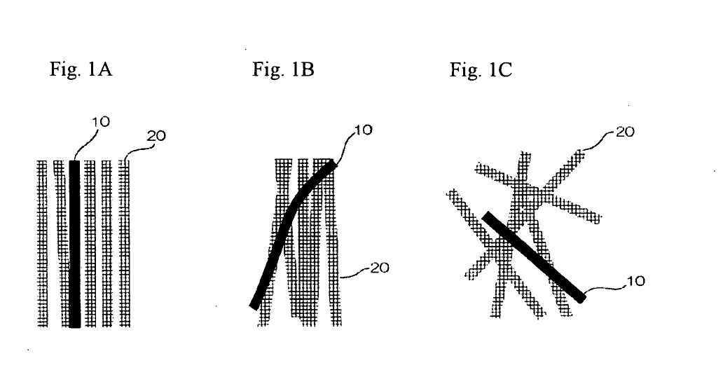

FIGS. 1A to 1C are schematic diagrams showing examples of the orientation condition of pulp fibers and magnetic fibers in relation to the fiber orientation ratio thereof. Concretely, they show the orientation condition of the pulp fibers and the magnetic fibers in recording paper with respect to the paper surface direction. In FIGS. 1A to 1C, 10 denotes a magnetic fiber, and 20 denotes a pulp fiber. FIG. 1A shows one example of the orientation condition of pulp fibers and magnetic fibers at a fiber orientation ratio within the range from 1.8 to 3.0. FIG. 1B shows one example of the orientation condition of pulp fibers and magnetic fibers at a fiber orientation ratio that is more than 1.3 but less than 1.8. FIG. 1C shows one example of the orientation condition of pulp fibers and magnetic fibers at a fiber orientation ratio within the range from 1.0 to 1.3.

When the fiber orientation ratio is within the range from 1.8 to 3.0 as in FIG. 1A, the contact between the pulp fibers and the magnetic fibers is reduced and, in addition, as compared with those in the case where the fiber orientation ratio is less than 1.8, the pulp fibers and the magnetic fibers are apt to be oriented almost in the same direction, and therefore the magnetic fibers are not positioned to intersect with the pulp fibers. Accordingly, concentration of stress strain in the pulp layer positioned in the neighborhood of the magnetic fibers may be prevented.

On the other hand, when the fiber orientation ratio is within the range from 1.0 to 1.3 as in FIG. 1C, both the pulp fibers and the magnetic fibers are apt to be oriented at random and the magnetic fibers are positioned to intersect with the pulp fibers, as compared to the case where the fiber orientation ratio is more than 1.3. However, since the fiber orientation is at random, the pulp fibers and the magnetic fibers contact and cross each other with a relatively large angle therebetween, and therefore the contact site between them is nearly a point contact and concentration of stress strain in the pulp layer positioned in the neighborhood of the magnetic fibers may be prevented.

In contrast, when the fiber orientation ratio is within the range from more than 1.3 to less than 1.8 as in FIG. 1B, then the orientation condition is an intermediate orientation condition between random orientation and the monoaxial orientation, as compared with the cases of FIG. 1A and FIG. 1C. Accordingly, the pulp fibers and the magnetic fibers contact and cross each other with a relatively small angle therebetween, and the contact area tends to be large. As a result, stress strain readily concentrates in the pulp layer positioned in the neighborhood of the magnetic fibers.

For reference, in almost all commercially available ordinary electrophotographic transfer paper, the fiber orientation ratio is within the range from more than 1.3 to less than 1.8.

When the fiber orientation ratio is within the range from 1.8 to 3.0, it is more preferably within the range from 2.0 to 3.0, even more preferably from 2.1 to 3.0. When the fiber orientation ratio is within the range from 1.0 to 1.3, it is more preferably within the range from 1.0 to 1.25, even more preferably from 1.0 to 1.2.

For controlling the fiber orientation ratio to fall within the range from 1.8 to 3.0, employable is a method of increasing the jet-wire ratio (the wire feeding speed in a papermaking machine/the ejection pressure (or the ejection speed) at ejecting a paper stock slurry that contains magnetic fibers and pulp fibers to the wire); or a method of making paper with a cylinder papermaking machine. For controlling the fiber orientation ratio to fall within the range from 1.0 to 1.3, employable is a method of reducing the jet-wire ratio. However, methods for controlling the fiber orientation ratio usable in the invention are not limited to these methods.

In an exemplary embodiment of the invention, the fiber orientation ratio means a value measured according to an ultrasonic wave traveling velocity method, and the value is represented by the ultrasonic wave traveling velocity of the recording paper in the Machine Direction (MD) thereof (in the paper conveyance direction in the papermaking machine) divided by the ultrasonic wave traveling velocity thereof in the Cross Direction (CD) (in the direction orthogonal to the paper conveyance direction in the papermaking machine). Concretely, the fiber orientation ratio is represented by the following formula (1):

Fiber orientation ratio (T/Y ratio) of recording paper according to ultrasonic wave traveling velocity method=(ultrasonic wave traveling velocity in MD direction)/(ultrasonic wave traveling velocity in CD direction). Formula (1)

The fiber orientation ratio according to the ultrasonic wave traveling velocity method may be measured with Sonic Sheet Tester (by Nomura Shoji Co., Ltd.). In this case, the possible lowermost limit of the fiber orientation ratio is 1.0.

The constitutive materials, the production method and the physical properties of the recording paper according to the exemplary embodiment of the invention are described in more detail hereinunder.

### —Magnetic fibers—

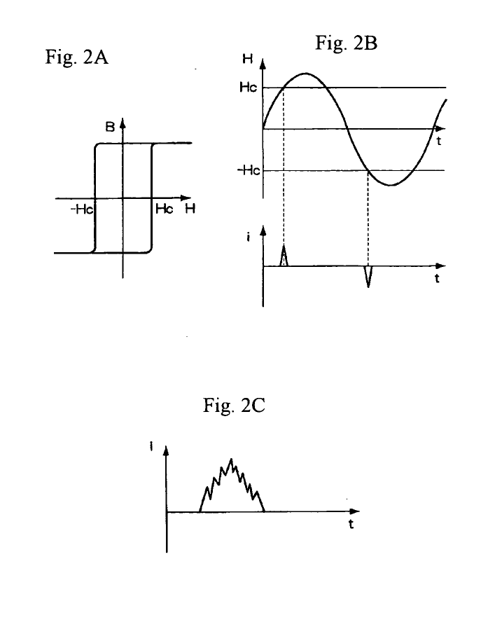

The magnetic fibers to be contained in the recording paper according to the exemplary embodiment of the invention may have a large Barkhausen effect. The large Barkhausen effect is described briefly. FIG. 2A to 2C explains the large Barkhausen effect. The large Barkhausen effect is a phenomenon in which rapid reversal of magnetism occurs in a material having such B—H characteristics as described in FIG. 2A (i.e., having a nearly rectangular hysteresis loop and a relatively small coercive force (Hc)), such as an amorphous magnetic fiber made of Co—Fe—Ni—B—Si, is put in an alternating magnetic field. Accordingly, when a magnetic fiber is put in the alternating magnetic field generated by application of an alternating current to an exciting coil, pulse current flows through the detector coil disposed near the magnetic fiber during reversal of magnetization.

For example, when an alternating magnetic field shown in the upper panel of FIG. 2B is generated by an exciting coil, the pulse current shown in the lower panel of FIG. 2B flows through a detector coil.

However, since the alternating current induced by the alternating magnetic field also flows through the detector coil, the pulse current is detected in the state of being superposed on the alternating current. When a material containing plural magnetic fibers is put in an alternating magnetic field, plural pulse currents are superposed so that the current as shown in FIG. 2C is detected.

The magnetic material for the magnetic fibers contained in the recording paper according to the exemplary embodiment of the invention may be generally a permanent magnet, and examples thereof include rare earth-containing magnetic materials such as those containing neodymium (Nd)-iron (Fe)-boron (B) as main components and those containing samarium (Sm)-cobalt (Co) as main components; alnico-containing magnetic materials such as those containing aluminium (Al)-nickel (Ni)-cobalt (Co) as main components; ferrite-containing magnetic materials such as those containing barium (Ba) or strontium (Sr), and iron oxide (Fe₂O₃) as main components; soft magnetic materials; and oxide-soft magnetic materials. Preferred for use herein is an amorphous magnetic material having a basic composition of Fe—Co—Si or Co—Fe—Ni.

The shape of the magnetic fibers is not particularly limited, and may be in any oblong (linear) shape suitable to exhibit a large Barkhausen effect. In order to exhibit a large Barkhausen effect, the magnetic fibers should have a predetermined length relative to the cross-sectional area thereof, and thus the form of a wire or a strip is basically preferable. From the viewpoint of reducing the contact area thereof with pulp fibers, the magnetic fibers are more preferably wire-shaped, still more preferably has a cross-section that is substantially in the shape of a complete circle.

When the magnetic fibers are in the form of a wire, the diameter of the magnetic fibers is preferably at least 10 μm, more preferably at least 20 μm in order to exhibit a large Barkhausen effect. The maximum diameter of the magnetic fibers is not particularly limited, and is preferably 100 μm or less, more preferably 60 μm or less from the viewpoint of prevention of cockle. In order to prevent exposure of the magnetic material on the paper surface, the diameter of the magnetic fibers may be less than the paper thickness. For example, in the case of paper having a thickness of about 90 μm, the diameter of the magnetic fibers is preferably 40 μm or less, more preferably 30 μm or less.

For attaining a large Barkhausen effect, the length of the magnetic fibers is preferably at least 10 mm, more preferably at least 15 mm. The maximum length of the magnetic fibers is preferably 300 mm or less, more preferably 50 mm or less from the viewpoint of the prevention of cockle.

Regarding the diameter and the length of the magnetic fibers, it is desirable that the diameter and the length of all the magnetic fibers contained in the recording paper fall in the above-mentioned ranges. When such values have distribution, it is preferable that at least the mean values fall in the above-mentioned ranges.

The recording paper according to the exemplary embodiment of the invention contains, in addition to the magnetic fibers, pulp fibers as a main component. In addition, the recording paper may contain, as necessary, various materials that are used in ordinary paper media. The layer constitution of the recording paper according to the exemplary embodiment of the invention is not particularly limited, and may have at least a paper substrate that contains pulp fibers as a main component. The paper substrate may have a multi-layered structure having two or more layers. The magnetic fibers, together with the pulp fibers, are contained in the paper substrate.

The pulp fibers as a main component of the paper substrate are not particularly limited. Examples thereof include broadleaf tree and/or conifer kraft pulp fibers, sulfite pulp fibers, semichemical pulp fibers, chemiground pulp fibers, ground wood pulp fibers, refiner-ground pulp fibers, and thermomechanical pulp fibers. Fibers obtained by chemically modifying cellulose or hemicellulose in any of the above fibers are also usable in accordance with the necessity.

Further examples include any one of the following fibers and any combination of fibers selected from the following fibers: cotton pulp fibers, hemp pulp fibers, kenaf pulp fibers, bagasse pulp fibers, viscose rayon fibers, regenerated cellulose fibers, copper ammonia rayon fibers, cellulose acetate fibers, polyvinyl chloride fibers, polyacrylonitrile fibers, polyvinyl alcohol fibers, polyvinylidene chloride fibers, polyolefin fibers, polyurethane fibers, polyvinyl chloride fibers, fluorocarbon fibers, glass fibers, carbon fibers, alumina fibers, metal fibers, silicon carbide fibers, and the like.

The Taber abrasion amount and the internal bonding intensity may be improved if necessary by using fibers that are prepared by infiltrating or thermally fusing a synthetic resin such as polyethylene, polypropylene, polystyrene, polyvinyl chloride, polyester into or onto any of the above pulp fibers.

In addition, high-quality or middle-quality recycled paper pulp may be incorporated into the above pulp fibers. The amount of the recycled paper pulp to be added may be determined depending on the use and the object. For example, when recycled paper pulp is added, its amount is preferably at least 10% by mass, more preferably at least 30% by mass, based on the total amount of pulp fibers contained in the paper substrate, from the viewpoint of natural resources protection. Also from the viewpoint of natural resources protection, it is desirable to use pulp obtained from chips of certified woods in so-called certified forests, planted woods or thinned woods.

A filler may be added, as necessary, to the paper substrate for use in the recording paper according to the exemplary embodiment of the invention so as to control the opacity, the whiteness and the surface condition of the paper.

As being granular, the filler, when added to the paper substrate, may exist in the region of contact between the magnetic fibers and the pulp fibers to exhibit an effect of further reducing the contact area between the magnetic fibers and the pulp fibers. Accordingly, in the exemplary embodiment of the invention, it is preferable to use a filler from the viewpoint of preventing cockle.

In this case, the amount of the filler contained in the recording paper is preferably at least 10% by mass, more preferably at least 12% by mass. If the filler content is less than 10% by mass, the effect of further preventing cockle may not be exhibited insufficiently. However, when the filler content is too large, paper powder may be generated easily and the paper strength may lower to cause easy loss of the magnetic fibers. Accordingly, the filler content is preferably 25% by mass or less.

The above-mentioned effect of further preventing cockle achieved by addition of the filler is more remarkable when the fiber orientation ratio is from 1.8 to 3.0 than when the fiber orientation is from 1.0 to 1.3. Accordingly, when the filler is added, the fiber orientation ratio may be within the range from 1.8 to 3.0.

The type of the filler usable in the paper substrate is not particularly limited. Examples thereof include: calcium carbonate-containing fillers such as ground calcium carbonate, precipitated calcium carbonate, chalk; silicates such as kaolin, calcined clay, pyrophyllite, sericite, and talc; other inorganic fillers such as titanium dioxide, calcium sulfate, barium sulfate, zinc oxide, zinc sulfide, zinc carbonate, aluminium silicate, calcium silicate, magnesium silicate, synthetic silica, aluminium hydroxide, alumina, white carbon, saponite, dolomite, calcium montmorillonite, sodium montmorillonite, and bentonite; and organic fillers such as acrylic plastic pigments, polyethylene, chitosan particles, cellulose particles, polyamino acid particles, and styrene. From the viewpoint of improving the image durability and the whiteness in electrophotography, calcium carbonate may be added to neutral paper.

In addition, a sizing agent and other various chemicals may be added as internal or external additives to the paper substrate of the recording paper according to the exemplary embodiment of the invention.

The sizing agent that can be added to the paper substrate may be, for example, a rosin sizing agent, a synthetic sizing agent, a petroleum resin sizing agent, or a neutral sizing agent. In addition, in an exemplary embodiment, a combination of a fixing agent and a sizing agent such as sulfate band or cationated starch is used.

Among the above-mentioned sizing agents, it is preferable to use a neutral sizing agent such as an alkenylsuccinic anhydride sizing agent, an alkyl ketene dimer, an alkenyl ketene dimer, a neutral rosin, a petroleum sizing agent, an olefinic resin, or a styrene-acrylic resin, from the viewpoint of the storage stability of the recording paper after image formation. In addition, as a surface-sizing agent, any of the following or any combination of sizing agents selected from the following may be used: oxidation-modified starch, enzymatically modified starch, cellulose derivatives such as polyvinyl alcohol and carboxymethyl cellulose, styrene-acrylic latex, styrene-maleic acid latex, and acrylic latex.

In addition, a paper strengthening agent may be added as an internal or external additive to the paper substrate of the recording paper according to the exemplary embodiment of the invention.

Examples of the paper strengthening agent include starch, modified starch, vegetable gum, carboxymethyl cellulose, polyvinyl alcohol, modified polyvinyl alcohol, polyacrylamide, styrene-maleic anhydride copolymer, vinyl chloride-vinyl acetate copolymer, styrene-butadiene copolymer, polyacrylic esters, urea-formaldehyde resin, melamine-formaldehyde resin, dialdehyde starch, polyethyleneimine, epoxidated polyamide, polyamide-epichlorohydrin resin, methylolated polyamide, and chitosan derivatives. In an exemplary embodiment, only one of these materials is used. In another exemplary embodiment, a mixture of two or more of these materials is used.

In addition to the above, other various auxiliary additives that are added to ordinary paper media, such as a dye or a pH controller, may also be used.

In producing the recording paper according to the exemplary embodiment of the invention, a paper substrate prepared from a paper stock slurry that contains at least magnetic fibers and pulp fibers may be used. The recording paper may be produced using only the paper substrate; or the paper substrate may be laminated with another paper substrate prepared from a paper stock slurry not containing magnetic fibers, and the resultant multi-layered paper substrate may be used in producing the recording paper according to the exemplary embodiment of the invention.

Further the paper substrate may be coated with a size-pressing liquid to be mentioned hereinunder and may be provided with a pigment coating layer in the production of a recording paper, as necessary.

The papermaking method is not particularly limited. The papermaking method may be a multi-layer papermaking method. As an alternative, the papermaking may be conducted by using a Fourdrinier papermaking machine, a cylinder papermaking machine or a twin-wire papermaking system conventionally known in the art. The papermaking method may be an acidic papermaking method or a neutral papermaking method.

As the method of multi-layer papermaking, any of the cylinder papermaking method, the Fourdrinier papermaking method, the Fourdrinier/cylinder combined papermaking method, the multi-head box papermaking method, and the tanmo/Fourdrinier papermaking method may be used. For example, any of the methods described in detail in “The Latest Papermaking Technology—Theory and Practice” authored by Saburo Ishiguro (Seishi-Kagaku Kenkyujo, 1984); or the cylinder papermaking method using a series of plural cylinders may be used.

In an exemplary embodiment, the magnetic fibers are not exposed on the surface of the recording paper. If the magnetic fibers are exposed on the surface of the recording paper, the magnetic fibers may cause leakage in a transfer process of transferring a toner image formed on a photoreceptor or an intermediate transfer medium onto the recording paper during image formation in an electrophotographic system. Accordingly, the magnetic fibers may be located in an inner layer of the multi-layered paper substrate and/or the paper substrate may be coated with an additional layer so as to avoid exposure of the magnetic fibers on the surface of the recording paper.

The surface of the paper substrate (the surface of the outermost surface layer when there are plural paper substrates in the recording paper) may be coated with a size-pressing liquid, such as those mentioned below.

The binder to be used in the size-pressing liquid may be an unprocessed starch such as corn starch, potato starch or tapioca starch, or a processed starch such as an enzymatically modified starch, phosphoric-esterified starch, cationized starch, or acetylated starch. In addition, other water-soluble polymers such as polyethylene oxide, polyacrylamide, sodium polyacrylate, sodium alginate, hydroxymethyl cellulose, carboxymethyl cellulose, methyl cellulose, polyvinyl alcohol, guar gum, casein, curdlane, and their derivatives may also be used. Only one of the water-soluble polymers may be used, or a combination of two or more of the water-soluble polymers may be used. However, binders usable in the invention are not limited thereto. From the viewpoint of the production cost thereof, starch, which is less expensive, is often used.

The recording paper according to the exemplary embodiment of the invention contains magnetic fibers. Therefore, when the surface of the magnetic fibers is not coated with an insulating layer or the like made of resin, metal oxide or the like, the electric resistance of the region around the magnetic fibers may lower easily. Accordingly, when an image is formed by electrophotography, local transfer failure may occur in and around the region where the magnetic fibers exist during transferring of a toner image formed on the surface of a photoreceptor or an intermediate transfer medium onto the paper, whereby there may be white spots in the formed image.

From such a viewpoint, the surface resistivity and the volume resistivity of the recording paper may be adjusted within predetermined ranges at which the generation of the white spots is suppressed. For the resistance control, a resistance controller or a combination of resistance controllers may be added to the recording paper according to the exemplary embodiment of the invention. Examples of the resistance controller include inorganic materials such as sodium chloride, potassium chloride, calcium chloride, sodium sulfate, zinc oxide, titanium dioxide, tin oxide, aluminium oxide, and magnesium oxide, and organic materials such as salts of alkyl phosphate esters, salts of alkyl sulfate esters, sodium sulfonate, and quaternary ammonium salts. As the method for incorporating the resistance controller to the recording paper, such an inorganic or organic material may be added to the size-pressing liquid followed by application of the size-pressing liquid onto the surface of the paper substrate.

For applying the size-pressing liquid onto the surface of the paper substrate (the surface of the outermost layer when there are plural paper substrates in the recording paper), a size press or an commonly used coater may be used, such as a shim size, a gate roll, a roll coater, a bar coater, an air-knife coater, a rod-blade coater, or a blade coater.

A pigment layer coating liquid that mainly includes an adhesive and a pigment may be applied onto at least one surface of the recording paper according to the exemplary embodiment of the invention to form a pigment layer, such that the paper obtained can be used as coat paper.

For obtaining highly glossy images, a resin layer may be provided on the pigment layer.

The resin for the resin layer is not particularly limited, and may be any known thermoplastic resin. Examples thereof include resins having ester bonds; polyurethane resins; polyamide resins such as urea resins; polysulfone resins; polyvinyl chloride resins; polyvinylidene chloride resins; vinyl chloride-vinyl acetate copolymer resins; vinyl chloride-vinyl propionate copolymer resins; polyol resins such as polyvinyl butyral resins; cellulose resins such as ethyl cellulose resins and cellulose acetate resins; polycaprolactone resins; styrene-maleic anhydride resins; polyacrylonitrile resins; polyether resins; epoxy resins; phenolic resins; polyolefin resins such as polyethylene resins and polypropylene resins; copolymer resins of an olefin, such as ethylene or propylene, and one or more other vinyl monomers; and acrylic resins.

The adhesive to be contained in the pigment layer coating liquid may be a water-soluble polymer compound, a water-dispersible polymer compound, or a combination of a water-soluble polymer compound and a water-dispersible polymer compound. Examples thereof include starches such as cationic starch, amphoteric starch, oxidized starch, enzymatically modified starch, thermochemically modified starch, esterified starch, and etherified starch; cellulose derivatives such as carboxymethyl cellulose and hydroxyethyl cellulose; natural or semi-synthetic polymer compounds such as gelatin, casein, soybean protein, natural rubber; polyvinyl alcohol; polydienes such as isoprene, neoprene, and polybutadiene; polyalkenes such as polybutene, polyisobutylene, polypropylene, and polyethylene; polymers and copolymers of vinylic compounds such as vinyl halides, vinyl acetate, styrene, (meth)acrylic acid, (meth)acrylic esters, (meth)acrylamide, and methyl vinyl ether; styrene-butadiene-based or methyl methacrylate-butadiene-based synthetic rubber latexes; and other synthetic polymer compounds such as polyurethane resins, polyester resins, polyamide resins, olefin-maleic anhydride resins, and melamine resins. One, or two or more of these polymer compounds may be selected appropriately and used in accordance with the intended quality of the recording paper.

Examples of the pigment to be contained in the pigment layer coating liquid include mineral pigments such as ground calcium carbonate, precipitated calcium carbonate, kaolin, calcined kaolin, structural kaolin, delaminated kaolin, talc, calcium sulfate, barium sulfate, titanium dioxide, zinc oxide, alumina, magnesium carbonate, magnesium oxide, silica, magnesium aluminosilicate, particulate calcium silicate, particulate magnesium carbonate, particulate precipitated calcium carbonate, white carbon, bentonite, zeolite, sericite, smectite; and organic pigments such as polystyrene resin, styrene-acrylic copolymer resin, urea resin, melamine resin, acrylic resin, vinylidene chloride resin, benzoguanamine resin, as well as fine hollow particles and through-hole type particles thereof Only one pigment may be used, or two or more pigments may be used.

The blend ratio of the adhesive to the pigment in the pigment layer coating liquid mentioned above is preferably from 5 to 50 parts by mass based on 100 parts by mass of the pigment. If the blend ratio of the adhesive relative to 100 parts by mass of the pigment is less than 5 parts by mass, then there may be problems in that the film strength of the coating layer is low and paper dust is generated. On the other hand, when the ratio is more than 50 parts by mass, the amount of adhesive is excessive, thus increasing the production cost, and reducing practicality.

The pigment layer coating liquid may further contain other various auxiliary additives as necessary, such as a surfactant, a pH controller, a viscosity controller, a softener, a surface-gloss imparting agent, a dispersant, a flowability controller, a conductance inhibitor, a stabilizer, an antistatic agent, a crosslinking agent, an antioxidant, a sizing agent, a fluorescent brightener, a colorant, a UV absorbent, a defoaming agent, a water-proofing agent, a plasticizer, a lubricant, a preservative, and a fragrance.

The amount of the pigment layer coating liquid to be applied to the recording paper may be suitably determined depending on the use and the object of the recording paper according to the exemplary embodiment of the invention. In general, an amount of the liquid that can completely cover the surface irregularity of the recording paper is preferable, and may be from 2 to 20 g/m² per one surface in terms of dry mass, preferably 2 to 8 g/m² in consideration of the cost.

In the method for applying the pigment layer coating liquid onto the surface of the paper substrate that has been coated with the above size-pressing liquid, any common known coating device may be appropriately used, such as a blade coater, an air-knife coater, a roll coater, a reverse-roll coater, a bar coater, a curtain coater, a die coater, a gravure coater, a champlex coater, a brush coater, a two-roll or metering blade-type size-press coater, a billbrade coater, a short dwell coater, and a gate roll coater.

The pigment coating layer provided on the paper substrate may serve as the surface layer of the recording paper. In an exemplary embodiment, only one surface of the recording layer has a pigment coating layer as the surface layer. In another embodiment, both surfaces of the recording layer have a pigment coating layer as the surface layer. The surface layer may have a multi-layered structure having one inter layer or having two or more interlayers as necessary. When the pigment coating layers are provided on the both surfaces of the recording medium, or when the surface layer has a multi-layer structure, the amounts of the coating liquids for forming the respective layers are not necessarily the same, and the kinds and amounts of the materials contained in each coating solution are not necessarily the same. Such factors may be adjusted appropriately in accordance with the desired quality level as long as the ranges specified above are satisfied.

When the pigment layer is provided on one surface of the recording paper, improvement in curl prevention, printability, and paper feed and discharge characteristics may be achieved by providing a synthetic resin layer, a coating layer that includes an adhesive and a pigment, or an antistatic layer on the other surface of the recording paper.

Naturally, adaptability to various applications may be provided by subjecting the other surface of the recording layer to any of various post processing treatments, such as a treatment for improving adhesiveness, magnetism, flame retardancy, heat resistance, water proofness, oil proofness, or anti-lubricity.

The recording medium according to the exemplary embodiment of the invention may be subjected to a smoothing treatment using a smoothing treatment apparatus, such as a super calender, a gloss calender, or a soft calender, after the sizing agent, the size-pressing liquid, the pigment layer coating liquid, and the like are optionally applied onto the surface of the paper substrate of the recording paper according to the exemplary embodiment of the invention. In addition, the smoothing may be conducted on-machine or off-machine as appropriate. The form of the compression apparatus, the number of compression nips, the heating temperature, and the like may be adjusted as appropriate in the same manner as in the case of common smoothing treatment apparatuses.

The basis weight (JIS P8124, which is incorporated herein by reference) of the recording medium according to the exemplary embodiment of the invention is not particularly specified, but may be, for example, 60 g/m² or more. If the basis weight is less than 60 g/m², the stiffness of the recording medium is decreased; as a result, when used in an electrophotographic image forming apparatus, there occurs problems in that the recording medium winds around the fixing apparatus in the fixing process in which the transferred toner image on the recording medium is fixed, and in that image defects easily occurs due to failure to separate from the fixing apparatus. Likewise, when the basis weight is less than 60 g/m², there may be problems upon application to an electrophotographic or ink jet image forming apparatus, in that the magnetic fibers contained in the recording medium is exposed on the recording medium surface, and in that the visibility of the image is worsened due to the exposure of the magnetic fibers on the recording medium surface.

Further, when the recording medium is prepared from the paper substrate, the moisture content may be adjusted with a paper machine or the like, such that the product moisture content immediately after a moisture proof packaging in which the recording medium is sealed is opened is in an adequate range, specifically, approximately from 3 to 6.5% by mass, more preferably approximately from 4.5 to 5.5% by mass. In order to prevent moisture absorption or desorption of the manufactured recording medium during storage, a predetermined number of sheets of the produced recording medium may be packed using a moisture proof packaging paper such as a polyethylene laminated paper, or a material such as polypropylene.

### EXAMPLES

The exemplary embodiment of the invention will be described more concretely with reference to the following Examples. However, the Examples should not be construed as limiting the scope of the invention.

### Example 1

90 parts by mass of LBKP (freeness (CSF)=400 ml), 10 parts by mass of NBKP (freeness (CSF)=450 ml), and 15 parts by mass of magnetic fibers (composition: Fe—Co—Si, length 30 mm, diameter 30 μm) are mixed to give a pulp slurry, and 0.7 parts by mass of polyacrylamide resin (trade name: PS3874-20, manufactured by Arakawa Chemical Industries, Ltd.) serving as a paper strengthening agent is added thereto. The resultant mixture is diluted with white water to prepare a paper stock slurry having a pH of 5.8 and a solid matter concentration of 0.4%.

Using Oriented Sheet Former (trade name; manufactured by Kumagai Riki Kogyo Co., Ltd.), the paper stock slurry is made into paper at a wire speed of 1200 m/min and a stock slurry ejection pressure of 0.5 kg/cm². Using a square sheet machine press (manufactured by Kumagai Riki Kogyo Co., Ltd.), the paper is pressed under a pressure of 5 kgf/cm² for 10 minutes. Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper having a basis weight of 80 g/m².

### Example 2

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent is added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 1500 m/min and a stock slurry ejection pressure of 0.4 kg/cm², the paper stock slurry is made into a first paper substrate layer having a basis weight of 30 g/m².

Next, a second paper stock slurry prepared by further adding 15 parts by mass of magnetic fibers (composition: Fe—Co—B, length 30 mm, diameter 30 μm) to the first paper stock slurry is applied onto the first paper substrate layer, using Oriented Sheet Former (trade name; manufactured by Kumagai Riki Kogyo Co., Ltd.) at a wire speed of 1500 m/min and a stock slurry ejection pressure of 0.4 kg/cm², thereby forming a second paper substrate layer having a basis weight of 40 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### Example 3

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent, and 6 parts by mass of precipitated calcium carbonate (TAMAPEARL TP-121, manufactured by Okutama Kogyo Co., Ltd.) serving as a filler are added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 600 m/min and a stock slurry ejection pressure of 1.2 kg/cm², the paper stock slurry is made into a first paper substrate layer having a basis weight of 30 g/m².

Next, a second paper stock slurry prepared by further adding 15 parts by mass of magnetic fibers (composition: Fe—Si—B, length 30 mm, diameter 30 μm) to the first paper stock slurry is applied onto the first paper substrate layer, using Oriented Sheet Former (trade name; manufactured by Kumagai Riki Kogyo Co., Ltd.) at a wire speed of 600 m/min and a stock slurry ejection pressure of 1.2 kg/cm², thereby forming a second paper substrate layer having a basis weight of 40 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### Example 4

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent, and 6 parts by mass of precipitated calcium carbonate (TAMAPEARL TP-121, manufactured by Okutama Kogyo Co., Ltd.) serving as a filler are added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 600 m/min and a stock slurry ejection pressure of 1.5 kg/cm², the paper stock slurry is made into a first paper substrate layer having a basis weight of 30 g/m².

Next, a second paper stock slurry prepared by further adding 15 parts by mass of magnetic fibers (composition: Fe—Co—B, length 30 mm, diameter 30 μm) to the first paper stock slurry is applied onto the first paper substrate layer, using Oriented Sheet Former (trade name; manufactured by Kumagai Riki Kogyo Co., Ltd.) at a wire speed of 600 m/min and a stock slurry ejection pressure of 1.5 kg/cm², thereby forming a second paper substrate layer having a basis weight of 40 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### Example 5

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent, and 3 parts by mass of precipitated calcium carbonate (TAMAPEARL TP-121, manufactured by Okutama Kogyo Co., Ltd.) serving as a filler are added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 1200 m/min and a stock slurry ejection pressure of 0.6 kg/cm², the paper stock slurry is made into a first paper substrate layer having a basis weight of 30 g/m².

Next, a second paper stock slurry prepared by further adding 15 parts by mass of magnetic fibers (composition: Fe—Co—Si, length 50 mm, diameter 30 μm) to the first paper stock slurry is applied onto the first paper substrate layer, using Oriented Sheet Former (trade name; manufactured by Kumagai Riki Kogyo Co., Ltd.) at a wire speed of 1200 m/min and a stock slurry ejection pressure of 0.6 kg/cm², thereby forming a second paper substrate layer having a basis weight of 40 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### Example 6

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent, and 3 parts by mass of precipitated calcium carbonate (TAMAPEARL TP-121, manufactured by Okutama Kogyo Co., Ltd.) serving as a filler are added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 1200 m/min and a stock slurry ejection pressure of 0.6 kg/cm², the paper stock slurry is made into a first paper substrate layer having a basis weight of 30 g/m².

Next, a second paper stock slurry prepared by further adding 15 parts by mass of magnetic fibers (composition: Fe—Co—B, length 100 mm, diameter 30 μm) to the first paper stock slurry is applied onto the first paper substrate layer, using Oriented Sheet Former (trade name; manufactured by Kumagai Riki Kogyo Co., Ltd.) at a wire speed of 1200 m/min and a stock slurry ejection pressure of 0.6 kg/cm², thereby forming a second paper substrate layer having a basis weight of 40 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### Example 7

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent, and 3 parts by mass of precipitated calcium carbonate (TAMAPEARL TP-121, manufactured by Okutama Kogyo Co., Ltd.) serving as a filler are added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 600 m/min and a stock slurry ejection pressure of 1.2 kg/cm², the paper stock slurry is made into a first paper substrate layer having a basis weight of 30 g/m².

Next, a second paper stock slurry prepared by further adding 15 parts by mass of magnetic fibers (composition: Fe—Co—B, length 290 mm, diameter 30 μm) to the first paper stock slurry is applied onto the first paper substrate layer, using Oriented Sheet Former (trade name; manufactured by Kumagai Riki Kogyo Co., Ltd.) at a wire speed of 600 m/min and a stock slurry ejection pressure of 1.2 kg/cm², thereby forming a second paper substrate layer having a basis weight of 40 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### Example 8

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent, and 13.5 parts by mass of precipitated calcium carbonate (TAMAPEARL TP-121, manufactured by Okutama Kogyo Co., Ltd.) serving as a filler are added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 1200 m/min and a stock slurry ejection pressure of 0.5 kg/cm², the paper stock slurry is made into a first paper substrate layer having a basis weight of 30 g/m².

Next, a second paper stock slurry prepared by further adding 15 parts by mass of magnetic fibers (composition: Fe—Co—B, length 20 mm, diameter 30 μm) to the first paper stock slurry is applied onto the first paper substrate layer, using Oriented Sheet Former (trade name; manufactured by Kumagai Riki Kogyo Co., Ltd.) at a wire speed of 1200 m/min and a stock slurry ejection pressure of 0.5 kg/cm², thereby forming a second paper substrate layer having a basis weight of 40 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### Example 9

90 parts by mass of LBKP (freeness (CSF)=400 ml), 10 parts by mass of NBKP (freeness (CSF)=450 ml) and 15 parts by mass of magnetic fiber (composition: Fe—Co—Si, length 30 mm, diameter 90 μm) are mixed to give a pulp slurry, and 0.7 parts by mass of polyacrylamide resin (trade name: PS3874-20, manufactured by Arakawa Chemical Industries, Ltd.) serving as a paper strengthening agent, and 3 parts by mass of precipitated calcium carbonate (TAMAPEARL TP-121, manufactured by Okutama Kogyo Co., Ltd.) serving as a filler are added thereto. The resultant mixture is diluted with white water to prepare a paper stock slurry having a pH of 5.8 and a solid matter concentration of 0.4%.

Using Oriented Sheet Former (trade name; manufactured by Kumagai Riki Kogyo Co., Ltd.) at a wire speed of 1200 m/min and a stock slurry ejection pressure of 0.6 kg/cm², the paper stock slurry is made into paper. Using a square sheet machine press (manufactured by Kumagai Riki Kogyo Co., Ltd.), the paper is pressed under a pressure of 5 kgf/cm² for 10 minutes. Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper having a basis weight of 150 g/m².

### Example 10

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent, and 11 parts by mass of precipitated calcium carbonate (TAMAPEARL TP-121, manufactured by Okutama Kogyo Co., Ltd.) serving as a filler are added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 1200 m/min and a stock slurry ejection pressure of 0.6 kg/cm², the paper stock slurry is made into a first paper substrate layer having a basis weight of 30 g/m².

Next, a second paper stock slurry prepared by further adding 15 parts by mass of magnetic fibers (composition: Fe—Co—Si, length 30 mm, diameter 20 μm) to the first paper stock slurry is applied onto the first paper substrate layer, using Oriented Sheet Former (trade name; manufactured by Kumagai Riki Kogyo Co., Ltd.) at a wire speed of 1200 m/min and a stock slurry ejection pressure of 0.6 kg/cm², thereby forming a second paper substrate layer having a basis weight of 40 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### Comparative Example 1

90 parts by mass of LBKP (freeness (CSF)=400 ml), 10 parts by mass of NBKP (freeness (CSF)=450 ml) and 15 parts by mass of magnetic fiber (composition: Fe—Co—Si, length 30 mm, diameter 30 μm) are mixed to give a pulp slurry, and 0.7 parts by mass of polyacrylamide resin (trade name: PS3874-20, manufactured by Arakawa Chemical Industries, Ltd.) serving as a paper strengthening agent is added thereto. The resultant mixture is diluted with white water to prepare a paper stock slurry having a pH of 5.8 and a solid matter concentration of 0.4%.

Using Oriented Sheet Former (trade name; manufactured by Kumagai Riki Kogyo Co., Ltd.) at a wire speed of 800 m/min and a stock slurry ejection pressure of 1.0 kg/cm², the paper stock slurry is made into paper. Using a square sheet machine press (manufactured by Kumagai Riki Kogyo Co., Ltd.), the paper is pressed under a pressure of 5 kgf/cm² for 10 minutes. Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper having a basis weight of 80 g/m².

### Comparative Example 2

90 parts by mass of LBKP (freeness (CSF)=400 ml), 10 parts by mass of NBKP (freeness (CSF)=450 ml) and 15 parts by mass of magnetic fiber (composition: Fe—Co—Si, length 30 mm, diameter 30 μm) are mixed to give a pulp slurry, and 0.7 parts by mass of polyacrylamide resin (trade name: PS3874-20, manufactured by Arakawa Chemical Industries, Ltd.) serving as a paper strengthening agent and 13.5 parts by mass of precipitated calcium carbonate (TAMAPEARL TP-121, manufactured by Okutama Kogyo Co., Ltd.) serving as a filler are added thereto. The resultant mixture is diluted with white water to prepare a paper stock slurry having a pH of 5.8 and a solid matter concentration of 0.4%.

Using Oriented Sheet Former (trade name; manufactured by Kumagai Riki Kogyo Co., Ltd.) at a wire speed of 800 m/min and a stock slurry ejection pressure of 1.0 kg/cm², the paper stock slurry is made into paper. Using a square sheet machine press (manufactured by Kumagai Riki Kogyo Co., Ltd.), the paper is pressed under a pressure of 5 kgf/cm² for 10 minutes. Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper having a basis weight of 80 g/m².

### Comparative Example 3

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent, and 3 parts by mass of precipitated calcium carbonate (TAMAPEARL TP-121, manufactured by Okutama Kogyo Co., Ltd.) serving as a filler are added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 800 m/min and a stock slurry ejection pressure of 1.0 kg/cm², the paper stock slurry is made into a first paper substrate layer having a basis weight of 30 g/m².

Next, a second paper stock slurry prepared by further adding 15 parts by mass of magnetic fibers (composition: Fe—Co—B, length 100 mm, diameter 110 μm) to the first paper stock slurry is applied onto the first paper substrate layer, using Oriented Sheet Former (trade name; manufactured by Kumagai Riki Kogyo Co., Ltd.) at a wire speed of 800 m/min and a stock slurry ejection pressure of 0.8 kg/cm², thereby forming a second paper substrate layer having a basis weight of 140 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### Comparative Example 4

90 parts by mass of LBKP (freeness (CSF)=400 ml) and 10 parts by mass of NBKP (freeness (CSF)=450 ml) are mixed to give a pulp slurry, and 0.7 parts by mass of polyacrylamide resin (trade name: PS3874-20, manufactured by Arakawa Chemical Industries, Ltd.) serving as a paper strengthening agent, and 11 parts by mass of precipitated calcium carbonate (TAMAPEARL TP-121, manufactured by Okutama Kogyo Co., Ltd.) serving as a filler are added thereto. The resultant mixture is diluted with white water to prepare a first paper stock slurry having a pH of 5.8 and a solid matter concentration of 0.4%.

Using Oriented Sheet Former (trade name; manufactured by Kumagai Riki Kogyo Co., Ltd.) at a wire speed of 1200 m/min and a stock slurry ejection pressure of 0.55 kg/cm², the paper stock slurry is made into a first paper substrate layer having a basis weight of 30 g/m².

Next, a second paper stock slurry prepared by further adding 15 parts by mass of magnetic fibers (composition: Fe—Co—Si, length 30 mm, diameter 20 μm) to the first paper stock slurry is applied onto the first paper substrate layer, using Oriented Sheet Former (trade name; manufactured by Kumagai Riki Kogyo Co., Ltd.) at a wire speed of 1200 m/min and a stock slurry ejection pressure of 0.55 kg/cm², thereby forming a second paper substrate layer having a basis weight of 40 g/m².

Next, the first paper stock slurry is again applied onto the second paper substrate layer under the same condition as that in forming the first paper substrate layer, thereby forming a third paper substrate layer having a basis weight of 30 g/m².

Finally, the paper is pressed under a pressure of 5 kgf/cm² for 10 minutes, using a square sheet machine press (manufactured by Kumagai Riki Kogyo Co., Ltd.). Then, using a rotary drier (Rotary Drier DR-200, trade name; manufactured by Kumagai Riki Kogyo Co., Ltd.), the paper is dried at a drum temperature of 80° C. and a rotating speed of 120 cm/min to give recording paper.

### —Evaluation—

The fiber orientation ratio of each of the thus-obtained recording paper is measured and its surface is visually checked to confirm the degree of cockle. The results of the evaluation of cockle are shown in Table 1, together with the fiber orientation ratio and other properties of the recording paper.

TABLE 1

| | | | | | Fiber Orientation | | | |
|---|---|---|---|---|---|---|---|---|
| | Magnetic Fibers | | | | Ration (by | | | Test Result |
| | | | | Large | ultrasonic wave | Filler | Layer Structure of Fiber | Cockle around |
| | | Length | Diameter | Barkhausen | traveling velocity | Content | Substrate | magnetic |
| | Composition | (mm) | (μm) | Effect | method) | (mass %) | (basis weight; g/m²) | fibers |
| Example 1 | Fe—Co—Si | 30 | 30 | observed | 1.8 | 0 | single layer (80) | B |
| Example 2 | Fe—Co—B | 30 | 30 | observed | 2.5 | 0 | triple layer (30/40/30) | A |
| Example 3 | Fe—Si—B | 30 | 30 | observed | 1.3 | 5 | triple layer (30/40/30) | A |
| Example 4 | Fe—Co—B | 30 | 30 | observed | 1.05 | 5 | triple layer (30/40/30) | A |
| Example 5 | Fe—Co—Si | 50 | 30 | observed | 2.0 | 2 | triple layer (30/40/30) | A |
| Example 6 | Fe—Co—B | 100 | 30 | observed | 2.0 | 2 | triple layer (30/40/30) | B |
| Example 7 | Fe—Co—B | 290 | 30 | observed | 1.3 | 2 | triple layer (30/40/30) | B |
| Example 8 | Fe—Co—B | 20 | 30 | observed | 1.8 | 12 | triple layer (30/40/30) | A |
| Example 9 | Fe—Co—Si | 30 | 90 | observed | 2.0 | 2 | single layer (150) | B |
| Example 10 | Fe—Co—Si | 30 | 20 | observed | 2.0 | 10 | triple layer (30/40/30) | A |
| Comparative | Fe—Co—Si | 30 | 30 | observed | 1.6 | 0 | single layer (80) | D |
| Example 1 | | | | | | | | |
| Comparative | Fe—Co—Si | 30 | 30 | observed | 1.6 | 12 | single layer (80) | D |
| Example 2 | | | | | | | | |
| Comparative | Fe—Co—B | 100 | 110 | observed | 1.4 | 2 | triple layer (30/140/30) | D |
| Example 3 | | | | | | | | |
| Comparative | Fe—Co—Si | 30 | 20 | observed | 1.7 | 10 | triple layer (30/40/30) | D |
| Example 4 | | | | | | | | |

In Table 1, the evaluation criteria for cockle is as follows:
A: Cockle is not observed at all in and around the region that contains magnetic fibers.
B: Slight cockle is observed in and around the region that contains magnetic fibers.
C: Cockle is observed in and around the region that contains magnetic fibers, but the degree of cockle is such that transfer failure in image formation with an electromagnetic image forming apparatus does not occur. This level is not practically problematic.
D: Remarkable cockle is observed in and around the region that contains magnetic fibers, and the degree of cockle is such that transfer failure occurs in image formation with an electromagnetic image forming apparatus. This level is practically problematic.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording paper comprising pulp fibers and magnetic fibers, the recording paper having a fiber orientation ratio within the range from about 1.8 to about 3.0 or the range from about 1.0 to about 1.3 as measured by an ultrasonic wave traveling velocity method.

2. The recording paper according to claim 1, wherein a length of the magnetic fibers is within the range from about 10 mm to about 300 mm.

3. The recording paper according to claim 1, wherein a diameter of the magnetic fibers is within the range from about 10 μm to about 100 μm.

4. The recording paper according to claim 1, further comprising a filler, wherein a content of the filler is at least about 10% by mass of the recording paper.

5. The recording paper according to claim 1, wherein the magnetic fibers exhibit a large Barkhausen effect.

6. The recording paper according to claim 1, wherein the fiber orientation ratio is from about 1.8 to about 3.0.

7. The recording paper according to claim 1, wherein the fiber orientation ratio is from about 2.1 to about 3.0.

8. The recording paper according to claim 1, wherein the fiber orientation ratio is from about 1.0 to about 1.3.

9. The recording paper according to claim 1, wherein the fiber orientation ratio is from about 1.0 to about 1.2.

10. The recording paper according to claim 1, wherein the magnetic fibers are made of an amorphous magnetic material comprising Fe—Co—Si or Co—Fe—Ni as the main composition of the amorphous magnetic material.

11. The recording paper according to claim 1, wherein the magnetic fibers are made of a magnetic material comprising Fe—Co—B as the main composition of the magnetic material.

12. The recording paper according to claim 4, wherein the fiber orientation ratio is from about 1.8 to about 3.0.

13. The recording paper according to claim 4, wherein the filler is calcium carbonate.

14. The recording paper according to claim 1, further comprising a paper strengthening agent.

15. A recording paper comprising pulp fibers and magnetic fibers, the recording paper having a fiber orientation ratio within the range from about 1.8 to about 3.0 or the range from about 1.0 to about 1.3 as measured by an ultrasonic wave traveling velocity method, the recording paper having a plurality of paper substrate layers, and the magnetic fibers being contained only in one or more internal substrate layers of the paper substrate layers.

16. The recording paper according to claim 1, wherein the magnetic fibers are contained in a paper substrate layer of the recording paper, and a coated layer is provided on or above the paper substrate layer.

17. The recording paper according to claim 1, wherein at least one surface of the recording paper has a pigment coating layer whose main constituents are adhesive and pigment.
